(19) United States
(12) Patent Application Publication
(10) Pub. No.: US 2022/0094798 A1
(43) Pub. Date: Mar. 24, 2022

(54) IMAGE FORMATION APPARATUS, RECORDING MEDIUM, AND CONTROL METHOD

(71) Applicant: SHARP KABUSHIKI KAISHA, Sakai City (JP)

(72) Inventor: Daisuke KASHIWAGURA, Sakai City (JP)

(21) Appl. No.: 17/399,765

(22) Filed: Aug. 11, 2021

(30) Foreign Application Priority Data
Sep. 18, 2020 (JP) 2020-156890

(51) Int. Cl. H04N 1/00; G06F 3/01

(52) U.S. Cl. CPC H04N 1/00381; H04N 1/00411; G06F 3/017

(57) ABSTRACT

The image formation apparatus includes a display including a plurality of LEDs. The display also includes infrared sensors that detect a gesture that is a movement of a hand of a user. On the display, when some of the plurality of LEDs are turned on, a home screen for selecting a function executable by the image formation apparatus, a screen for selecting an operation condition in various types of functions, a screen for confirming the selected function and operation condition, and a screen for executing the function are displayed, and a gesture for instructing an instructable content is notified in each screen. The user views the screen and instructs a desired content with a gesture.

### BACKGROUND OF THE INVENTION

### Field of the Invention

The present invention relates to an image formation apparatus, a recording medium, and a control method, and more particularly relates to, for example, an image formation apparatus, a recording medium, and a control method by which it is possible to instruct setting of an operation condition and execution of an operation with a gesture.

### Description of the Background Art

An example of this type of image formation apparatus is disclosed in Japanese Unexamined Patent Application Publication No. 2018-67875 (hereinafter, Patent Document 1). In an image formation system disclosed in Patent Document 1, a glass type terminal stores an operation instruction in association with a gesture, and based on a captured image of a front view of a user, recognizes the gesture and receives the operation instruction. If the received operation instruction is a document reading instruction, the glass type terminal detects a printed matter from the image, cuts the detected printed matter as a document image, and transmits the cut document image to an image formation apparatus.

In the conventional technology, it is possible to recognize the gesture of the user to print the document image, for example, but an imaging apparatus for recognizing the gesture is needed, and further, it is necessary to execute a gesture recognition process, and thus, costs for the apparatus and the process are expensive.

In addition, it is possible for the user to apply the operation instruction with a gesture, but the user needs to remember the gesture corresponding to the operation instruction, or to perform a gesture while reading an instruction manual or the like describing the gesture corresponding to the operation instruction, and therefore, it is troublesome to apply the operation instruction.

Accordingly, a primary object of the present invention is to provide a novel image formation apparatus, recording medium, and control method.

Another object of the present invention is to provide an image formation apparatus, a recording medium, and a control method by which it is possible to easily and inexpensively apply an instruction with a gesture.

### SUMMARY OF THE INVENTION

A first invention is an image formation apparatus including a plurality of infrared sensors, a plurality of LEDs arranged around the plurality of infrared sensors, and a notifier that notifies an instructable content and a gesture for instructing the instructable content by turning on some of the plurality of LEDs.

A second invention depends upon the first invention, in which a display arranged with the plurality of LEDs is provided, and the plurality of infrared sensors are arranged at upper and lower areas or/and left and right areas of the display.

A third invention depends upon the second invention, in which some of the plurality of LEDs are arrayed linearly along the plurality of infrared sensors arrayed linearly at the upper and lower areas or/and left and right areas.

A fourth invention depends upon the second or third invention, in which the gesture includes a user moving a hand in an up-down direction or/and a left-right direction with respect to the display.

A fifth invention depends upon the fourth invention, in which the plurality of LEDs emit light according to a light emission pattern based on the gesture.

A sixth invention depends upon the fifth invention, in which the light emission pattern is a pattern in which the plurality of LEDs are turned on to notify a direction in which the user moves the hand.

A seventh invention depends upon the fifth invention, in which the light emission pattern is a pattern in which the plurality of LEDs are additionally turned on in a predetermined order with a predetermined time interval to notify a direction in which the user moves the hand.

An eighth invention depends upon any one of the first to seventh inventions, in which the instruction with the gesture includes an instruction for selecting any one of a plurality of functions provided in the image formation apparatus, an instruction for selecting an operation condition in each of the plurality of functions, and an instruction for executing or canceling the plurality of functions.

A ninth invention is a non-transitory recording medium for recording a control program of an image formation apparatus including a plurality of infrared sensors and a plurality of LEDs arranged around the plurality of infrared sensors, and the control program causes a processor of the image formation apparatus to execute a notification step for notifying an instructable content and a gesture for instructing the instructable content by tuning on some of the plurality of LEDs.

A tenth invention is a control method of an image formation apparatus including a plurality of infrared sensors and a plurality of LEDs arranged around the plurality of infrared sensors, and the control method includes notifying an instructable content and a gesture for instructing the instructable content by turning on some of the plurality of LEDs.

According to the present invention, it is possible to inexpensively and easily apply an instruction with a gesture.

The above object, other objects, features, and advantages of the present invention will be more apparent from the following detailed description of embodiments with reference to the drawings.

### BRIEF DESCRIPTION OF THE DRAWINGS

FIG. 1 is a perspective view illustrating an example of an external configuration of an image formation apparatus of the present embodiment.

FIG. 2 is a block diagram illustrating an example of an electrical configuration of the image formation apparatus of the present embodiment.

FIG. 3 is a diagram illustrating an example of a panel of a display illustrated in FIGS. 1 and 2.

FIG. 4 is a diagram illustrating an example of a configuration of electronic components of the display illustrated in FIGS. 1 and 2.

FIG. 5 is a diagram illustrating a first example of a home screen displayed on the display illustrated in FIGS. 1 and 2.

FIG. 6 is a diagram illustrating a second example of the home screen displayed on the display illustrated in FIGS. 1 and 2.

FIG. 7 is a diagram illustrating a third example of the home screen displayed on the display illustrated in FIGS. 1 and 2.

FIG. 8 is a diagram illustrating a fourth example of the home screen displayed on the display illustrated in FIGS. 1 and 2.

FIG. 9 is a diagram for explaining a manner in which an LED is turned on when a gesture of moving a hand in a right direction is notified on the display illustrated in FIGS. 1 and 2.

FIG. 10 is a diagram for explaining a manner in which an LED is turned on when a gesture of moving a hand in a downward direction is notified on the display illustrated in FIGS. 1 and 2.

FIG. 11 is a diagram for explaining a method of detecting a gesture of moving a hand in a right direction in a gesture detector illustrated in FIG. 2.

FIG. 12 is a diagram for explaining a method of detecting a gesture of moving a hand in a downward direction in a gesture detector illustrated in FIG. 2.

FIG. 13 is a diagram illustrating a first example of a confirmation screen displayed on the display illustrated in FIGS. 1 and 2.

FIG. 14 is a diagram illustrating a second example of the confirmation screen displayed on the display illustrated in FIGS. 1 and 2.

FIG. 15 is a diagram illustrating a first example of a color mode selection screen displayed on the display illustrated in FIGS. 1 and 2.

FIG. 16 is a diagram illustrating a second example of the color mode selection screen displayed on the display illustrated in FIGS. 1 and 2.

FIG. 17 is a diagram illustrating a first example of a number-of-copies selection screen displayed on the display illustrated in FIGS. 1 and 2.

FIG. 18 is a diagram illustrating a second example of a number-of-copies selection screen displayed on the display illustrated in FIGS. 1 and 2.

FIG. 19 is a diagram illustrating a first example of an execution screen displayed on the display illustrated in FIGS. 1 and 2.

FIG. 20 is a diagram illustrating a second example of the execution screen displayed on the display illustrated in FIGS. 1 and 2.

FIG. 21 is a diagram illustrating an example of a memory map of a RAM illustrated in FIG. 2.

FIG. 22 is a flowchart illustrating a first part of an example of an overall process of a CPU illustrated in FIG. 2.

FIG. 23 is a flowchart following FIG. 22 and illustrating a second part of the overall process of the CPU illustrated in FIG. 2.

FIG. 24 is a flowchart following FIG. 23 and illustrating a third part of the overall process of the CPU illustrated in FIG. 2.

FIG. 25 is a flowchart following FIGS. 23 and 24 and illustrating a fourth part of the overall process of the CPU illustrated in FIG. 2.

FIG. 26 is a flowchart illustrating a first part of an example of a gesture determination process of the CPU illustrated in FIG. 2.

FIG. 27 is a flowchart following FIG. 26 and illustrating a second part of the gesture determination process of the CPU illustrated in FIG. 2.

### DESCRIPTION OF THE PREFERRED EMBODIMENTS

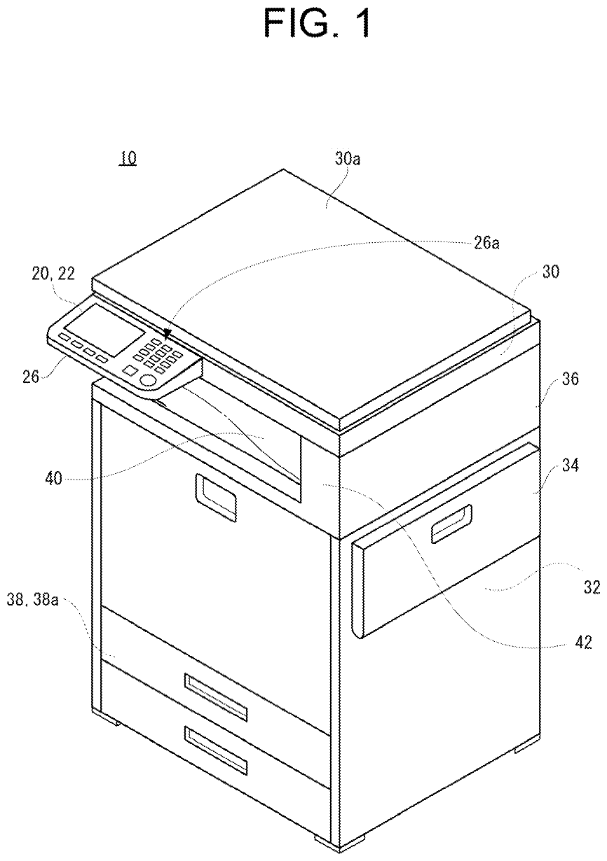

FIG. 1 is a perspective view illustrating an external configuration of an image formation apparatus 10, that is, one embodiment of the present invention. With reference to FIG. 1, in the present embodiment, the image formation apparatus 10 is a multifunction peripheral (MFP) having a copying function (that is, copy function), a printer function, a scanner function, a facsimile function, and the like.

It is noted that the present invention is applicable not only to such a multifunction peripheral but also to another image formation apparatus having at least one of a copy function, a scanner function, and a facsimile function.

Further, as used herein, if a direction is used in the description of a configuration of the image formation apparatus 10, a surface facing a user operating the image formation apparatus 10, that is, a surface on the side provided with an operation panel 26 described later, is set as an anterior surface (front surface), a front-rear direction (depth direction) of the image formation apparatus 10 and constituent components thereof is defined, and a left-right direction (lateral direction) of the image formation apparatus 10 and the constituent components thereof is defined with reference to a state where the image formation apparatus 10 is seen from the user.

The image formation apparatus 10 includes an apparatus main body 36 provided with an image reader 30, an image former 32, a manual paper feeder 34, a paper feeding device 38, and a paper ejection tray 40.

The image reader 30 includes a document platen formed of a transparent material (for example, contact glass or platen glass), and is built inside the apparatus main body 36. A document pressing cover 30a is attached to be freely opened and closed above the document platen via a hinge or the like.

It is noted that in the present embodiment, the document pressing cover 30a is not provided with a manual document feeder, but may be provided with the manual document feeder. In this case, the document pressing cover 30a is provided with an automatic document feeding device (ADF) that automatically feeds a document placed on the manual document feeder.

The image reader 30 includes a light source, a plurality of mirrors, an imaging lens, and a line sensor. The image reader 30 exposes a document surface with light from the light source, and guides reflected light reflected from the document surface to the imaging lens by the plurality of mirrors. The reflected light is imaged on a light receiving element of the line sensor by the imaging lens. The line sensor detects luminance or chromaticity of the reflected light imaged on the light receiving element to generate read image data, based on an image on the document surface. A charge coupled device (CCD), a contact image sensor (CIS), or the like is employed for the line sensor.

The image former 32 is built inside the apparatus main body 36 and is provided below the image reader 30. The image former 32 includes a photoconductive drum, a charging device, an exposure device, a developing device, a transfer device, and a fixing device. The image former 32 forms an image on an image recording medium (for example, paper) transferred from the manual paper feeder (or the paper feed tray) 34, the paper feeding device 38 (or the paper feed cassette 38a), or the like, by an electrophotographic method, and discharges the imaged paper to the paper ejection tray 40.

It is noted that read image data read by the image reader 30, image data transmitted from an external computer, or the like is employed for output image data used for forming the image on the paper.

A process for generating, from read image data, black/white or color output image data reflecting various types of settings and a black/white or color image formation process according to the output image data are already known and are different from the essential content of the invention of the present application, and thus, detailed description thereof will be omitted.

Although detailed description is omitted, the image formation apparatus 10 includes a color printing function, and the image former 32 includes four photoreceptor drums, four charging devices, four developing devices, four intermediate transfer rollers, and four cleaning devices, for respective colors of yellow (Y), magenta (M), cyan (C), and black (K). For each color, an image formation station including a photoconductive drum, a charging device, a developing device, a transfer roller, and a cleaning device is configured. The image formation apparatus 10 is a tandem-type image formation apparatus, and in the image former 32, the image formation stations for the respective colors are arranged in a row.

The manual paper feeder 34 is an example of a paper feeding means. Although detailed illustration is omitted, the manual paper feeder 34 is set with paper having an appropriate size. In the present embodiment, one manual paper feeder 34 is illustrated, but a plurality of the manual paper feeders 34 may be provided. The paper feeding device 38 is an example of a paper feeding means, similarly to the manual paper feeder 34. Although detailed illustration is omitted, the paper feeding device 38 includes one or more paper feed cassettes 38a. Each of the paper feed cassettes 38a is set with (or accommodates) paper having an appropriate size. The paper feeding device 38 supplies paper from any one of the paper feed cassettes 38a to the image former 32. As described above, the paper supplied to the image former 32 is subjected to an image forming process by the image former 32.

It is noted that if the image recording medium is supplied from the manual paper feeder 34, the manual paper feeder 34 is used while being opened to the apparatus main body 36, and the image recording medium is set on the opened manual paper feeder 34.

It is noted that the image recording medium is not limited to paper, and sheets other than paper such as a clear file and an OHP film can also be used.

The paper ejection tray 40 is provided between the image reader 30 and the image former 32. A bottom surface of the paper ejection tray 40 is partitioned by the image former 32. A top surface of the paper ejection tray 40 is partitioned by the image reader 30. A left side surface (left side surface when viewed from the front) of the paper ejection tray 40 is defined by a right side surface of a connection chassis 42. That is, the front surface side, the back surface side, and the left surface side of the paper ejection tray 40 are opened. The bottom surface of the paper ejection tray 40 has an inclined surface having a downward slope toward the connection chassis 42 side.

An operation panel 26 is provided on the front surface side of the image reader 30. The operation panel 26 includes a display 20 including an LCD 22 and a gesture detector 24, and a plurality of operation buttons 26a.

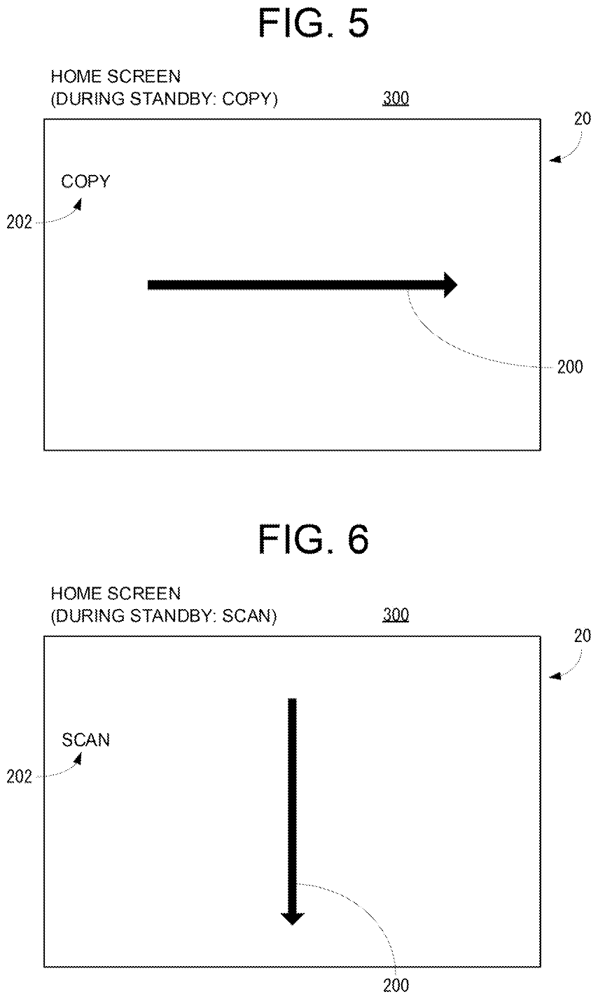

The display 20 displays various types of screens including a content of an instruction such as execution or cancellation of a function, a selection of a function, and a selection of an operation condition. In an example, the display 20 displays a home screen 300 (or a main menu screen) including a plurality of the home screens 300 and being a screen for selecting a desired function from various type of functions executable by the image formation apparatus 10, a screen (for example, a color mode selection screen 400 and a number-of-copies selection screen 450) for selecting an operation condition of each function, an execution screen 500 for executing or canceling each function, and a confirmation screen (350 and the like) for confirming user selection and setting, and the like (see FIGS. 5 to 8 and FIGS. 13 to 20). It is noted that in the present embodiment, the function means copying (including scanning a document), scanning, transmitting a fax, and an operation preset by the user (hereinafter, which may be referred to as “user preset”).

The LCD 22 is a general-purpose monochrome LCD and has a display region for displaying about several lines. Although detailed description will be omitted, in the present embodiment, the LCD 22 displays a status of the image formation apparatus 10, a file name of data being printed, an error code, and the like.

The gesture detector 24 is a detector that detects a gesture of the user, in the present embodiment, a movement of a hand of the user (including a state in which the movement of the hand is stopped). A configuration of the gesture detector 24 will be described later.

Each of the operation buttons 26a is a hardware key, and includes, for example, a home key, a clear key, a power saving key, a main power key, a mode selection key, and a numeric keypad. The home key is a key for displaying the below-described home screen 300 on the display 20. The clear key is a key for clearing an operation condition set by the user and returning to a default state. The power saving key is a key for switching between a power saving state in which power consumption is limited and a normal state in which power consumption is not limited. The mode selection key is a key for selecting a function (or an operation mode) such as copy, scan, and fax. The numeric keypad includes numeric keypads from 0 to 9, and in the present embodiment, also includes # and * keys.

On the other hand, the hardware key refers to a key or a press button provided as a physical device.

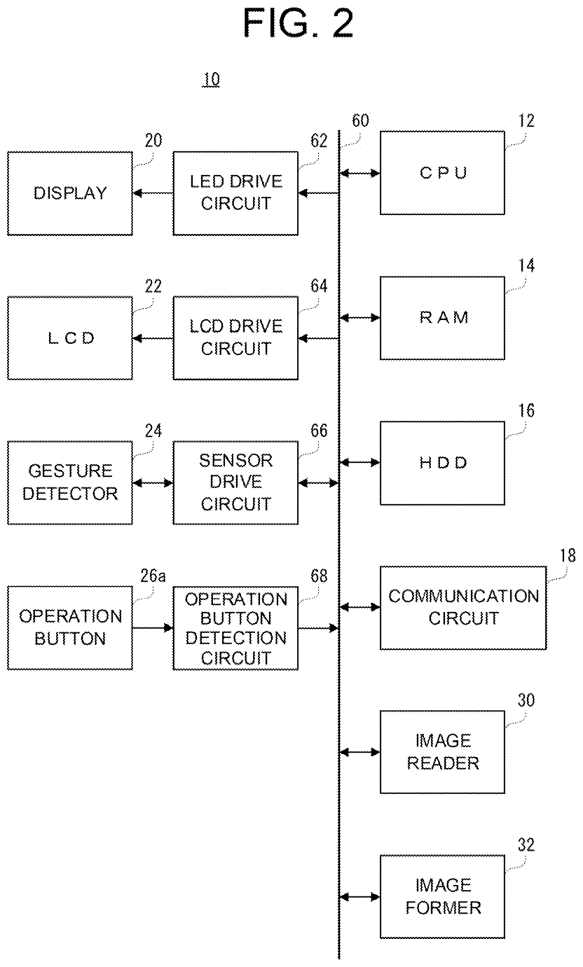

FIG. 2 is a block diagram illustrating an electrical configuration of the image formation apparatus 10 illustrated in FIG. 1. With reference to FIG. 2, the image formation apparatus 10 includes a CPU 12. The CPU 12 is connected, via a bus 60, to a RAM 14, an HDD 16, a communication circuit 18, the image reader 30, the image former 32, an LED drive circuit 62, an LCD drive circuit 64, a sensor drive circuit 66, and an operation button detection circuit 68.

The LED drive circuit 62 is connected to the display 20, the LCD drive circuit 64 is connected to the LCD 22, the sensor drive circuit 66 is connected to the gesture detector 24, and the operation button detection circuit 68 is connected to the operation button 26a.

The CPU 12 manages an overall control of the image formation apparatus 10. The RAM 14 is a main storage device of the image formation apparatus 10, and is used as a work area and a buffer area of the CPU 12.

The HDD 16 is an auxiliary storage device of the image formation apparatus 10, and appropriately stores a control program for causing the CPU 12 to control the operation of each part of the image formation apparatus 10, display data for various screens, data for the operation condition preset (that is, set as default) in the image formation apparatus 10, data of the document printed by the copy function of the image formation apparatus 10, and the like. However, other non-volatile memories such as an SSD, a flash memory, and an EEPROM may be provided in place of the HDD 16 or together with the HDD 16.

The communication circuit 18 includes a modem and a network interface card (NIC). The modem is a communication circuit for transmission and reception of facsimiles and is connected to a public telephone line. The NIC is a communication circuit for wired or wireless communication with an external computer such as a server or other electronic device via a network (LAN or/and the Internet), and is connected to, for example, an LAN.

The image reader 30 and the image former 32 are as described above, and thus, duplicated description will be omitted.

The LED drive circuit 62 controls turning on and off a plurality of LEDs configuring the display 20 under the instruction of the CPU 12. The plurality of LEDs in the present embodiment are color LEDs, and lighting color is also controlled.

The LCD drive circuit 64 controls a display of the LCD 22 described above under the instruction of the CPU 12. However, the LCD 22 may be omitted. In this case, the LCD drive circuit 64 is also omitted.

The sensor drive circuit 66 is a circuit for driving a plurality of infrared sensors 230 to 236 configuring the gesture detector 24. Specifically, under the instruction of the CPU 12, the sensor drive circuit 66 causes each light emitter of the infrared sensors 230 to 236 to emit light and outputs, to the CPU 12, a detection result indicating that infrared light is received by each light receiving part of the infrared sensors 230 to 236.

In the present embodiment, the plurality of infrared sensors 230 to 236 are each general-purpose pyroelectric infrared sensors. A detectable distance of each of the infrared sensors 230 to 236 is set to about several cm to about 10 cm. This setting is designed to detect only the hand of the user and not a face or a torso of the user.

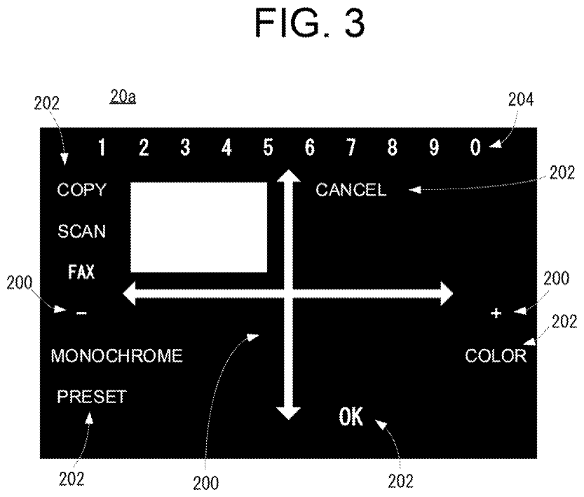

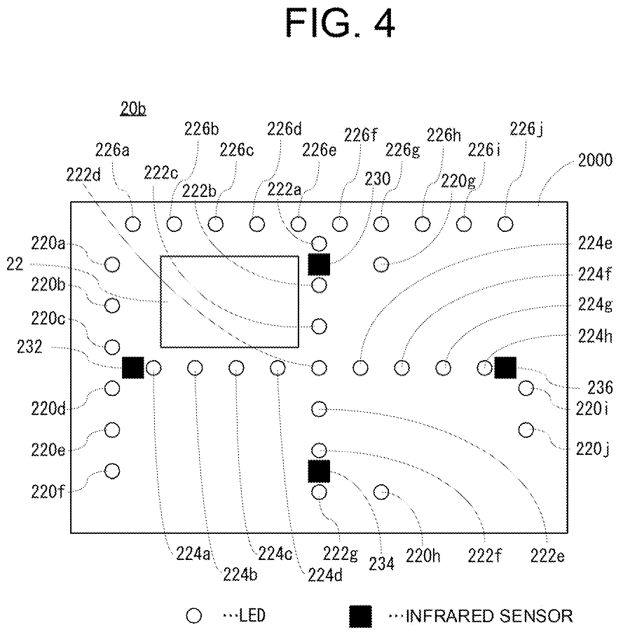

The display 20, the LCD 22, and the gesture detector 24 are configured by a panel 20a illustrated in FIG. 3 and electronic components 20b illustrated in FIG. 4. As can be seen from FIG. 4, the LCD 22 and the gesture detector 24 are built in the display 20.

As illustrated in FIG. 3, dark or black paint through which infrared light transmits is applied to the panel 20a on a bottom surface of a transparent acrylic plate, except for portions indicating a symbol 200 including a plurality of the symbols 200, a text (in the present embodiment, a character string 202 including a plurality of the character strings 202, a number 204 including a plurality of the numbers 204, and a graphic 206. In an example, the panel 20a (display 20) has the same or approximately the same size as a passport.

In an example illustrated in FIG. 3, the symbol 200 of an arrow indicating an up-down direction and a left-right direction is displayed at the center of the panel 20a. The character strings 202 of “Copy”, “Scan”, “Fax”, “Monochrome”, and “Preset”, and the symbol 200 of “−” are displayed to be vertically arranged at a left end of the panel 20a, and the symbol 200 of “+” and the character string 202 of “Color” are displayed to be vertically arranged at a right end of the panel 20a. At an upper end of the panel 20a, the numbers 204 of “1” to “9” and “0” are displayed to be arrayed from left to right. The character string 202 of “Cancel” is displayed on the right from a tip of an arrow at the upper side of the symbol 200 of an arrow indicating the up-down direction, and the character string 202 of “OK” is displayed on the right from a tip of an arrow at the lower side of the symbol 200 of an arrow indicating the up-down direction. The graphic 206 having a quadrangle shape is displayed on a left side from the symbol 200 of the arrow indicating the up-down direction and above the symbol 200 of the arrow indicating the left-right direction.

The symbol 200, the character string 202, and the number 204 are controlled to be displayed or not to be displayed by a plurality of LEDs 220a to 220j, 222a to 222g, 224a to 224h, and 226a to 226j which are each included in the electronic component 20b described later. A portion of the graphic 206 functions as a display panel (or a cover) of the LCD 22.

As illustrated in FIG. 4, the electronic component 20b includes an electronic substrate 2000, and the electronic substrate 2000 is implemented with the plurality of LEDs 220a to 220j, 222a to 222g, 224a to 224h, and 226a to 226j, the plurality of infrared sensors 230 to 236, and the LCD 22, at predetermined positions.

As can be seen also with reference to FIG. 3, specifically, the LED 220a is arranged at a position corresponding to the character string 202 of “Copy”, the LED 220b is arranged at a position corresponding to the character string 202 of “Scan”, the LED 220c is arranged at a position corresponding to the character string 202 of “FAX”, the LED 220d is arranged at a position corresponding to the symbol 200 of “−”, the LED 220e is arranged at a position corresponding to the character string 202 of “Monochrome”, and the LED 220f is arranged at a position corresponding to the character string 202 of “Preset”.

It is noted that the “corresponding position” means a coinciding or overlapping position when the panel 20a is overlapped with the electronic component 20b. Hereinafter, the same applies.

The LEDs 222a, 222b, 222c, 222d, 222e, 222f, and 222g are arrayed in the up-down direction (vertical direction) at a position corresponding to the symbol 200 of the arrow indicating the up-down direction.

The LEDs 224a, 224b, 224c, 224d, 224e, 224f, 224g, and 224h are arrayed in the left-right direction at a position corresponding to the symbol 200 of the arrow indicating the left-right direction.

It is noted that the symbol 200 of the arrow indicating the up-down direction crosses the symbol 200 of the arrow indicating the left-right direction, and thus, the LED 222d arranged at the crossing portion is used commonly for lighting on and off the symbols 200 of both the arrows.

The LED 226a is arranged at a position corresponding to the number 204 of “1”, the LED 226b is arranged at a position corresponding to the number 204 of “2”, the LED 226c is arranged at a position corresponding to the number 204 of “3”, the LED 226d is arranged at a position corresponding to the number 204 of “4”, the LED 226e is arranged at a position corresponding to the number 204 of “5”, the LED 226f is arranged at a position corresponding to the number 204 of “6”, the LED 226g is arranged at a position corresponding to the number 204 of “7”, the LED 226h is arranged at a position corresponding to the number 204 of “8”, the LED 226i is arranged at a position corresponding to the number 204 of “9”, and the LED 226j is arranged at a position corresponding to the number 204 of “0”.

In the present embodiment, the infrared sensor 230 is arranged between the LED 222a and the LED 222b, the infrared sensor 232 is arranged between the LED 220c (220d) and the LED 224a, the infrared sensor 234 is arranged between the LED 222f and the LED 222g, and the infrared sensor 236 is arranged between the LED 220i and the LED 224h.

In the present embodiment, the LCD 22 is arranged on the left of the LEDs 222b and 222c and above the LEDs 224a to 224d.

Returning to FIG. 2, the operation button detection circuit 68 outputs an operation signal or operation data in response to the operation of the operation button 26a described above, to the CPU 12.

It is noted that the electrical configuration of the image formation apparatus 10 illustrated in FIG. 2 is merely an example, and there is no need of the configuration being limited thereto. For example, the image formation apparatus 10 may include a connector such as a memory slot into which various types of storage devices such as an SD card or a USB memory can be installed.

In such an image formation apparatus 10, the user can apply an instruction (or an operation or input) with a gesture by his or her own hand. In the present embodiment, in the image formation apparatus 10, the gesture is assigned correspondingly to the function or the operation selectable (or executable) by the user, and in addition, in a situation where the user applies an instruction with the gesture, the gesture for the instructable content is previously notified by the LEDs 220a to 220j, 222a to 222g, 224a to 224h, and 226a to 226j emitting light. That is, the image formation apparatus 10 assists an instruction with a gesture.

Hereinafter, as used herein, if a direction is implied for description about display contents on the display 20 and a gesture, up-down and left-right directions obtained when the user views the display 20 from the front are used.

As used herein, only a case where the user applies an instruction with a gesture will be described, but a similar process is executed also when the user applies an instruction by the operation button 26a.

FIGS. 5 to 8 each illustrate an example of the home screen 300 when the user waits to apply an instruction with a gesture. The home screen 300 is set to contents (that is, a screen) displayed on the panel 20a of the display 20. In the home screen 300 illustrated in FIGS. 5 to 8, an outer frame of the panel 20a, and the symbol 200 and the character string 202 displayed (or lit up) are illustrated in black, and the others are illustrated in white. The same applies to the other screens below. The number 204 to be displayed is also illustrated in black as in the symbol 200 and the character string 202.

As described above, the home screen 300 is a screen for selecting the function in the image formation apparatus 10, and in the present embodiment, it is possible to select “Copy”, “Scan”, “FAX”, or “User preset”.

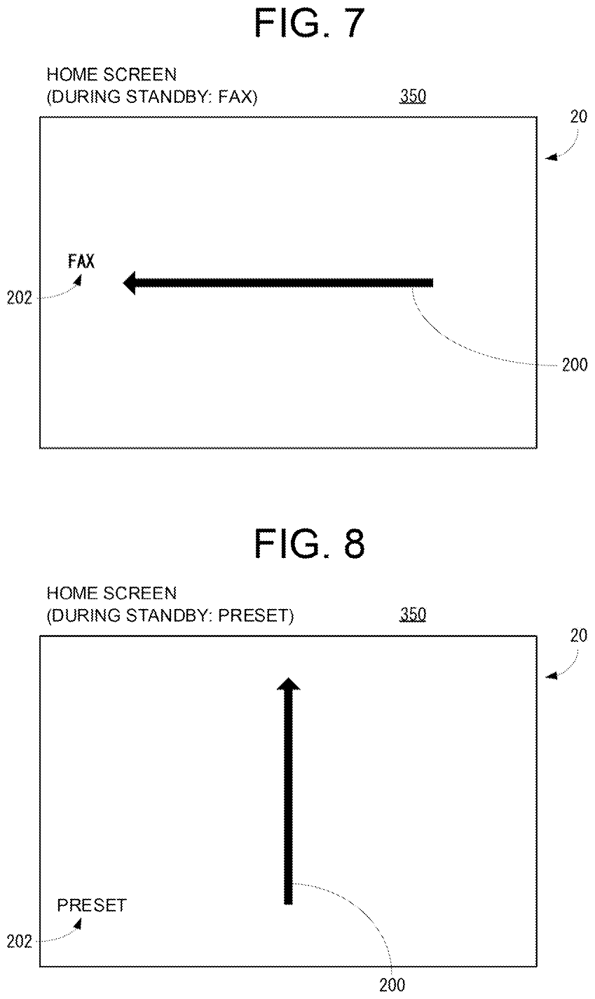

FIG. 5 is an example of the home screen 300 notifying the user of a gesture for selecting “Copy”. FIG. 6 is an example of the home screen 300 notifying the user of a gesture for selecting “Scan”. FIG. 7 is an example of the home screen 300 notifying the user of a gesture for selecting “FAX”. FIG. 8 is an example of the home screen 300 notifying the user of a gesture for selecting “User preset”.

It is noted that “User preset” is a function of executing an operation preset by the user, and corresponds to an operation of copying a document by a predetermined magnification and an operation for scanning a document to be output in a predetermined format such as PDF, for example.

In the home screen 300 illustrated in FIG. 5, the character string 202 of “Copy” is displayed and the symbol 200 of the rightward arrow is displayed. In the present embodiment, the character string 202 of “Copy” and the symbol 200 of the rightward arrow are displayed in the same color (for example, yellow). That is, moving a hand rightward is notified to select “Copy”.

In the home screen 300 illustrated in FIG. 6, the character string 202 of “Scan” is displayed and the symbol 200 of the downward arrow is displayed. In the present embodiment, the character string 202 of “Scan” and the symbol 200 of the downward arrow are displayed in the same color (for example, green). That is, moving a hand downward is notified to select “Scan”.

In the home screen 300 illustrated in FIG. 7, the character string 202 of “FAX” is displayed and the symbol 200 of the leftward arrow is displayed. In the present embodiment, the character string 202 of “FAX” and the symbol 200 of the leftward arrow are displayed in the same color (for example, blue). That is, moving a hand leftward is notified to select “FAX”.

In the home screen 300 illustrated in FIG. 8, the character string 202 of “Preset” is displayed and the symbol 200 of the upward arrow is displayed. In the present embodiment, the character string 202 of “Preset” and the symbol 200 of the upward arrow are displayed in the same color (for example, red). That is, moving a hand upward is notified to select “User preset”.

As described above, in the home screen 300 illustrated in FIGS. 5 to 8, the rightward arrow, the downward arrow, the leftward arrow, and the upward arrow are displayed, and in the present embodiment, each of the arrows is changed to gradually extend from an arrowhead toward a tip of the arrow. When the entire arrow is displayed, the arrow is changed to gradually extend from the arrowhead toward the tip of the arrow again. Such a change is repeated several times (for example, three times) in each home screen 300.

In the present embodiment, different colors are assigned to each function, and a difference in function is also expressed by a color used for display. In an example, as described above, yellow is assigned to “Copy”, green is assigned to “Scan”, blue is assigned to “FAX”, and red is assigned to “User preset”.

Until the user applies an instruction to select one of the functions with a gesture, the home screens 300 illustrated in FIGS. 5 to 8 are displayed in that order, and when the home screen 300 illustrated in FIG. 8 is displayed, the home screens 300 illustrated in FIGS. 5 to 8 are displayed in this order, again. However, as described above, after the display of the arrow is repeated several times, the display is changed to the next home screen 300.

Here, a method of displaying the arrow and a method of detecting a user gesture will be described.

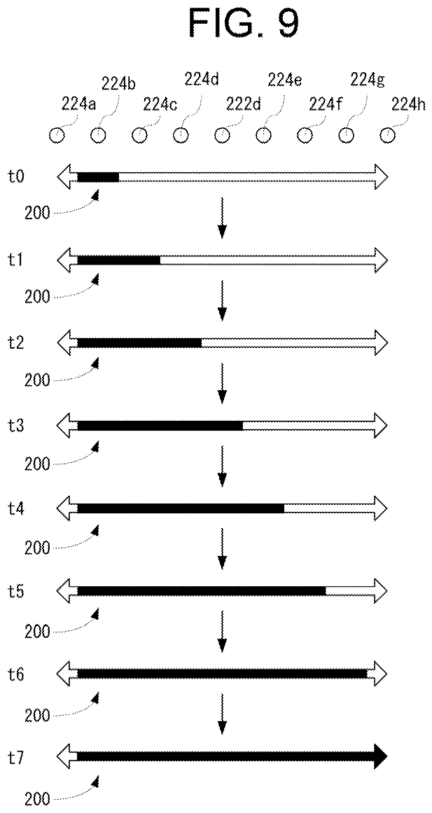

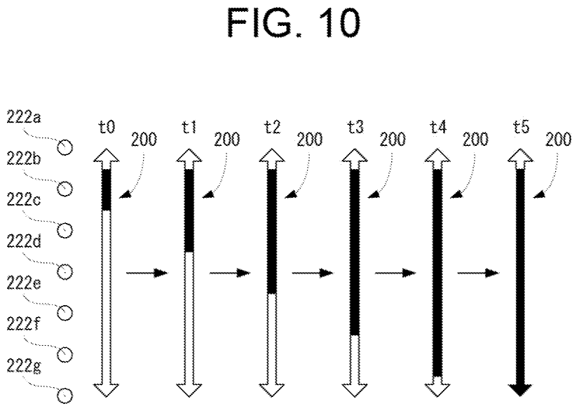

FIG. 9 is a diagram for describing a method of displaying the rightward arrow, and FIG. 10 is a diagram for describing a method of displaying the downward arrow.

FIG. 9 illustrates a state where the symbol 200 of the rightward arrow extends over time. In FIG. 9, the LEDs 224a, 224b, 224c, 224d, 222d, 224e, 224f, and 224h arranged at a position corresponding to the symbol 200 of the arrow indicating the left-right direction are displayed above the symbol 200 of the arrow indicating the left-right direction. Here, only the LED to be turned on will be described, and the LED not to be turned on will not be described. This applies to a case where the method of displaying the symbol 200 of the downward arrow is described, described later.

If the symbol 200 of the rightward arrow is displayed, the LEDs 224b, 224c, 224d, 222d, 224e, 224f, 224g, and 224h are additionally turned on in this order for each time obtained by equally dividing a first predetermined time period into eight parts during the first predetermined time period from a time t0 a time t7. In the present embodiment, the first predetermined time period is set to one second. The first predetermined time period is a time period during which a movement, that is, a gesture, can be detected by the infrared sensors 230 to 236 configuring the gesture detector 24 if the user moves the hand rightward, that is, makes the gesture, and is determined through an experiment. The first predetermined time period is an example, and is appropriately changed according to a capability of the infrared sensor to be used.

It is noted that the time t0 is a time when the symbol 200 of the rightward arrow is first displayed in the home screen 300 (the same applies to the other screens) and when the symbol 200 of the rightward arrow, including the tip of the arrow, is displayed, and then, the symbol 200 of the rightward arrow is again displayed from the arrowhead side.

Specifically, at the time to, the LED 224b is turned on, at the time t1, the LEDs 224b and 224c are turned on, at the time t2, the LEDs 224b, 224c, and 224d are turned on, at the time t3, the LEDs 224b, 224c, 224d, and 222d are turned on, at the time t4, the LEDs 224b, 224c, 224d, 222d, and 224e are turned on, at the time t5, the LEDs 224b, 224c, 224d, 222d, 224e, and 224f are turned on, at the time t6, the LEDs 224b, 224c, 224d, 222d, 224e, 224f, and 224g are turned on, and at the time t7, the LEDs 224b, 224c, 224d, 222d, 224e, 224f, 224g, and 224h are turned on.

Therefore, the symbol 200 of the rightward arrow is displayed to gradually extend. The LED 224a is turned on if the arrow tip of the symbol 200 of the leftward arrow is displayed, and thus, if the symbol 200 of the rightward arrow is displayed, the LED 224a is not turned on.

Although not illustrated, if the symbol 200 of the leftward arrow is displayed, the LEDs 224a, 224b, 224c, 224d, 222d, 224e, 224f, and 224g are controlled to be turned on so that the arrow extends in a direction opposite to the direction to display the symbol 200 of the rightward arrow. In this case, the LED 224h is not turned on.

FIG. 10 illustrates a state where the symbol 200 of the downward arrow extends over time. In FIG. 10, the LEDs 222a, 222b, 222c, 222d, 222e, 222f, and 224g arranged at a position corresponding to the symbol 200 indicating the up-down direction are illustrated at the left of the symbol 200 of the arrow indicating the up-down direction.

If the symbol 200 of the downward arrow is displayed, the LEDs 222b, 222c, 222d, 222e, 222f, 222g, and 222h are additionally turned on in this order for each time obtained by equally dividing the first predetermined time period into six parts during the first predetermined time period from the time t0 to the time t5.

It is noted that the time t0 is a time when the symbol 200 of the downward arrow is first displayed in the home screen 300 (the same applies to the other screens) and when the symbol 200 of the downward arrow, including the tip of the arrow, is displayed, and then, the symbol 200 of the downward arrow is again displayed from the arrowhead side.

Specifically, at the time to, the LED 222b is turned on, at the time t1, the LEDs 222b and 222c are turned on, at the time t2, the LEDs 222b, 222c, and 222d are turned on, at the time t3, the LEDs 222b, 222c, 222d, and 222e are turned on, at the time t4, the LEDs 222b, 222c, 222d, 222e, and 222f are turned on, and at the time t5, the LEDs 222b, 222c, 222d, 222e, 222f, and 222g are turned on.

Therefore, the symbol 200 of the downward arrow is displayed to gradually extend. The LED 222a is turned on if the arrow tip of the symbol 200 of the upward arrow is displayed, and thus, if the symbol 200 of the downward arrow is displayed, the LED 222a is not turned on.

Although not illustrated, if the symbol 200 of the upward arrow is displayed, the LEDs 222a, 222b, 222c, 222d, 222e, 222f, and 222g are controlled to be turned on so that the arrow extends in a direction opposite to the direction to display the symbol 200 of the downward arrow. In this case, the LED 222g is not turned on.

As described above, the home screens 300 illustrated in FIGS. 5 to 8 are each displayed in order, and on each of the home screens 300, the character string 202 indicating the function is displayed in a predetermined color, and the symbol 200 of the arrow notifying the gesture is displayed in a predetermined color a predetermined number of times. In order that the home screen 300 is thus displayed, display data for timings of turning on and off the LEDs 220a to 220j, 222a to 222g, 224a to 224h, and 226a to 226j, and lighting patterns including information on the colors to be lit is previously prepared and stored in the HDD 16. This also applies to the other screens described later.

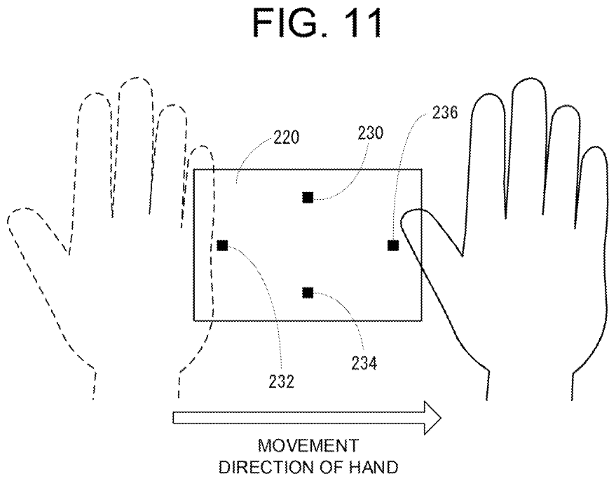

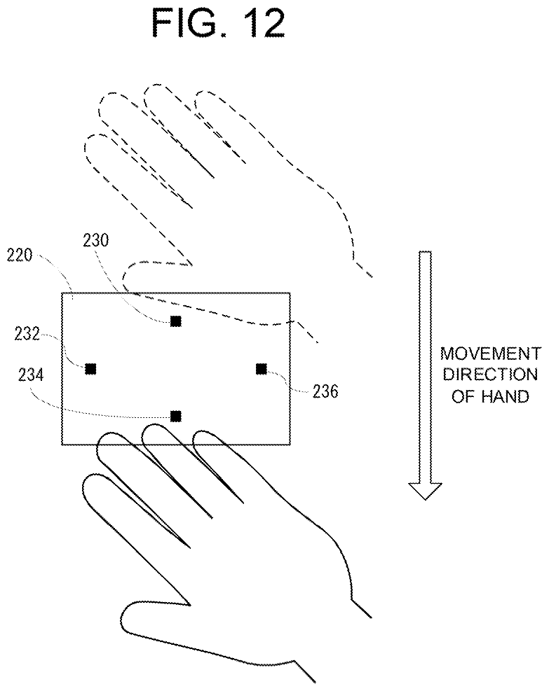

FIG. 11 is a diagram for describing a method of detecting a user gesture of moving the hand rightward (that is, “rightward movement”), and FIG. 12 is a diagram for describing a method of detecting a user gesture of moving the hand downward (that is, “downward movement”). It is noted that in FIGS. 11 and 12, the hand of the user immediately after starting the gesture is illustrated by a broken line, and the hand of the user immediately after finishing the gesture is illustrated by a solid line. FIGS. 11 and 12 illustrate only the infrared sensors 230 to 236, and omit the LEDs 220a to 220j, 222a to 222g, 224a to 224h, and 226a to 226j. It is noted that in the present embodiment, the display 20 is provided so that a display surface faces upward in the image formation apparatus 10, and thus, the user moves the hand above the display 20.

As illustrated in FIG. 11, when the user moves the hand from left to right above the display 20, an object (that is, the hand of the user) is firstly detected by the infrared sensor 232, the hand of the user is next detected by the infrared sensor 230 or/and the infrared sensor 234, and the hand of the user is finally detected by the infrared sensor 236.

At a timing allowing the user to execute the instruction with the gesture, outputs of the infrared sensors 230 to 236 are stored over time. In the present embodiment, if a time period from the start to the end of the gesture for the instruction with the gesture is over the first predetermined time period, the type of the gesture (in the present embodiment, the rightward movement, the leftward movement, the downward movement, and the upward movement) is determined.

It is noted that in the present embodiment, the start of the gesture occurs when a state where all the infrared sensors 230 to 236 do not detect an object is changed to a state where any one or more of the infrared sensors 230 to 236 detect an object, and the end of the gesture occurs when a state where any one or more of the infrared sensors 230 to 236 detect an object is changed to a state where all the infrared sensors 230 to 236 do not detect an object.

If the time period from the start to the end of the gesture is shorter than the first predetermined time period, it is not possible to distinguish between the instruction with the gesture and the hand of the user accidentally crossing above the display 20, and thus, it is determined that an error occurs in detecting an instruction with a gesture, and the user is notified of the error and an instruction with a gesture is to be detected again.

A method of notifying an error may include outputting a beep sound, blinking (repeatedly turning on and off) all (or some) of the LEDs 220a to 220j, 222a to 222g, 224a to 224h, and 226a to 226j in a predetermined color (for example, red), and executing the both. In another embodiment, a character string of an error may be displayed on the panel 20a, and an LED may be further provided at the position of the electronic substrate 2000 corresponding to the character string to display (light) the character string of the error.

Although not illustrated, if the user moves the hand toward a direction opposite to the direction illustrated in FIG. 11, that is, toward a position of a hand illustrated by a dashed line from a position of a hand illustrated by a solid line, the gesture of the user moving the hand leftward (that is, a “leftward movement”) is detected.

As illustrated in FIG. 12, when the user moves the hand downward from upward above the display 20, the hand of the user is firstly detected by the infrared sensor 230, the hand of the user is next detected by the infrared sensor 232 or/and the infrared sensor 236, and the hand of the user is finally detected by the infrared sensor 234.

Although not illustrated, if the user moves the hand toward a direction opposite to the direction illustrated in FIG. 12, that is, toward a position of a hand illustrated by a dashed line from a position of a hand illustrated by a solid line, the gesture of the user moving the hand upward (that is, an “upward movement”) is detected.

As mentioned above, in the present embodiment, the display 20 has the approximately same size as that of a passport, and thus, if the user correctly moves the hand leftward, rightward, upward, and downward, the hand of the user is detected by at least one of the infrared sensors 230 to 236 from the start to the end of the gesture.

Therefore, the type of the gesture of the user is determined by a direction from the infrared sensor (any one of 230 to 236) that detects the hand of the user at the start of the gesture to the infrared sensor (any one of 230 to 236) that detects the hand of the user at the end of the gesture.

It is noted that the method of determining the type of the gesture of the user is an example and does not need to be limited. When the number of infrared sensors increases, it is possible to closely track the movement of the hand of the user.

In the present embodiment, if the user does not continuously move the hand for at least a second predetermined time period (for example, three seconds) and puts the hand over the display 20, that is, if the user makes a gesture without moving the hand, it is determined that a specific operation is being executed. In an example, if the hand of the user is detected by at least one of the infrared sensors 230 to 236 and that state is continued for at least the second predetermined time period, it is determined that a specific operation is being executed.

In the following description, if the symbol 200 of the arrow is displayed, as described above, the turning on of the LEDs 222a to 222g and 224a to 224h is controlled, if the gesture of the user is detected, the type of the gesture is determined based on the detection result of the infrared sensors 230 to 236, as described above. Therefore, in the following, duplicated description will be omitted.

If the home screen 300 is displayed, when the user moves the hand from left to right above the display 20, the rightward movement is detected as the gesture and “Copy” is selected as the function. In the following, a case where “Copy” is selected, various types of operation conditions are set with a gesture, and “Copy” is further executed will be described.

It is noted that if the home screen 300 is displayed, the user may select a desired function by making a gesture for selecting a desired function irrespective of whether the notified gesture is for selecting the “Copy” function, the “Scan” function, the “Fax” function, or the “User preset function”.

In the present embodiment, yellow is assigned to “Copy”, and thus, the symbol 200 and the character string 202 are displayed in yellow in the screen (in the present embodiment, the color mode selection screen 400 and the number-of-copies selection screen 450) displayed when the operation condition for “Copy” is set. Therefore, although not illustrated, if another function is selected, the symbol 200 and the character string 202 are displayed in color assigned to the other function when the operation condition is set.

If “Copy” is selected, a screen (hereinafter, referred to as “confirmation screen”) 350 for confirming whether the selected content is acceptable is displayed on the display 20.

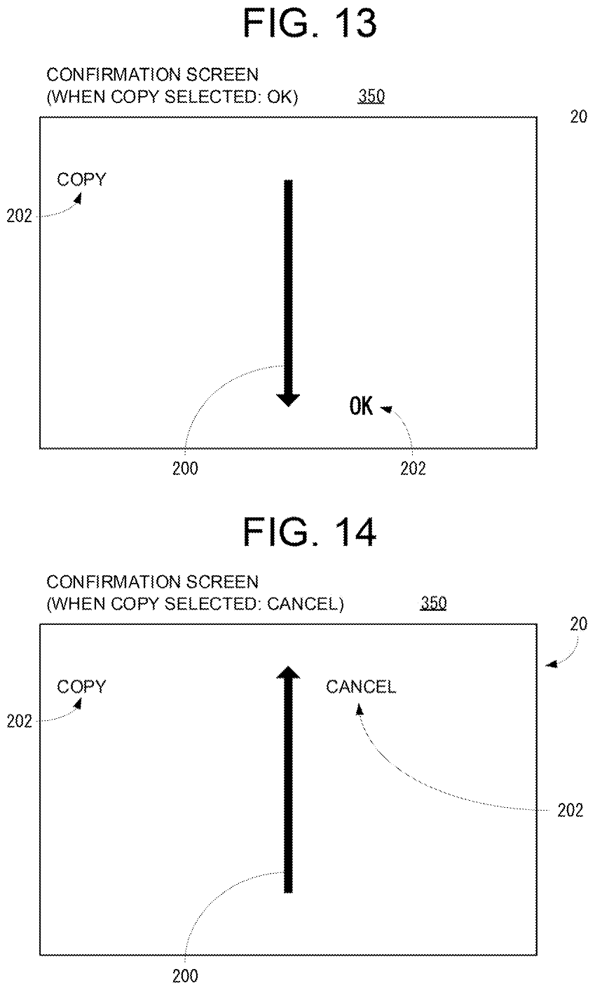

FIG. 13 illustrates a confirmation screen 350 for notifying a gesture for selecting that the selected function is acceptable (for selecting “OK”) when “Copy” is selected. FIG. 14 illustrates the confirmation screen 350 for notifying a gesture for selecting that the selected function (here, “Copy”) is canceled when “Copy” is selected.

In the confirmation screen 350 illustrated in FIGS. 13 and 14, the character string 202 of “Copy” is displayed in red. A reason why the character string 202 is displayed in red is to indicate that “Copy” is selected. The same applies when the operation condition is selected, as will be described later. In the confirmation screen 350 illustrated in FIG. 13, the character string 202 of “OK” and the symbol 200 of the downward arrow are displayed in green to notify a downward movement as a gesture for selecting “OK”. On the other hand, in the confirmation screen 350 illustrated in FIG. 14, the character string 202 of “Cancel” and the symbol 200 of the upward arrow are displayed in red to notify an upward movement as a gesture for selecting “Cancel”.

The confirmation screens 350 illustrated in FIGS. 13 and 14 are displayed alternately on the display 20 until “OK” or “Cancel” is selected, that is, until the downward movement or the upward movement is detected. It is noted that while the confirmation screen 350 illustrated in FIG. 13 is displayed, the symbol 200 of the downward arrow is displayed three times, and while the confirmation screen 350 illustrated in FIG. 14 is displayed, the symbol 200 of the upward arrow is displayed three times.

If the confirmation screen 350 is displayed on the display 20, when “Cancel” is selected, the screen returns to the home screen 300 to select the function again. On the other hand, when the confirmation screen 350 is displayed on the display 20, if “OK” is selected, a screen for selecting a color mode (hereinafter, referred to as “color mode selection screen”) 400 is next displayed on the display 20.

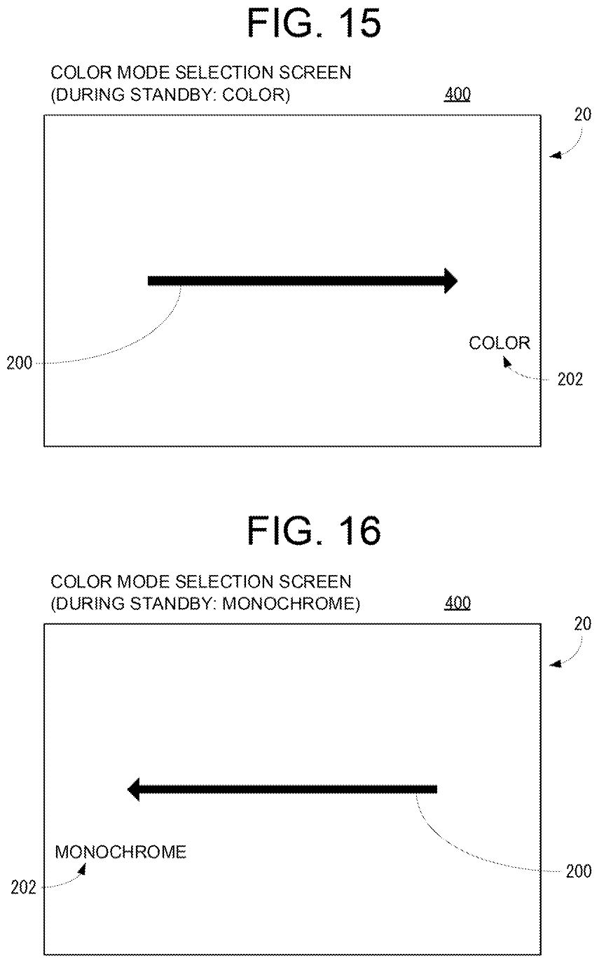

FIG. 15 illustrates the color mode selection screen 400 for notifying a gesture for selecting “Color”. FIG. 16 illustrates the color mode selection screen 400 for notifying a gesture for selecting “Monochrome”.

In the color mode selection screen 400 illustrated in FIG. 15, the character string 202 of “Color” and the symbol 200 of the rightward arrow are displayed in yellow to notify the rightward movement as a gesture for selecting “Color” as the color mode. On the other hand, in the color mode selection screen 400 illustrated in FIG. 16, the character string 202 of “Monochrome” and the symbol 200 of the leftward arrow are displayed in yellow to notify the leftward movement as a gesture for selecting “Monochrome” as the color mode.

The color mode selection screens 400 illustrated in FIGS. 15 and 16 are alternately displayed on the display 20 until “Color” or “Monochrome” is selected, that is, until the rightward movement or the leftward movement is detected. It is noted that while the color mode selection screen 400 illustrated in FIG. 15 is displayed, the symbol 200 of the rightward arrow is displayed three times, and while the color mode selection screen 400 illustrated in FIG. 16 is displayed, the symbol 200 of the leftward arrow is displayed three times.

It is noted that when the color mode selection screen 400 is displayed, if a specific operation is detected, “Copy” is forcibly executed according to the default setting. Hereinafter, when the execution screen 500 is displayed, if a specific operation is detected until execution of “Copy” is instructed, “Copy” is similarly forcibly executed according to the default setting.

When the color mode is selected, the confirmation screen (hereinafter, referred to as “color mode confirmation screen”) for confirming whether the selected color mode is acceptable is next displayed. The color mode confirmation screen is similar to the above confirmation screen 350, but in this case, to confirm whether “OK” or “Cancel” is selected for the color mode, the selected color mode, that is, the character string 202 of “Color” or “Monochrome” is displayed in red. The symbol 200 of the arrow when “OK” is selected and when “Cancel” is selected is the same in display as the confirmation screen 350.

If “Cancel” is selected for the color mode, the screen returns to the color mode selection screen 400 to select a color mode again. On the other hand, if “OK” is selected for the color mode, the screen 450 (hereinafter, referred to as “number-of-copies selection screen”) for selecting the number of copies is displayed on the display 20.

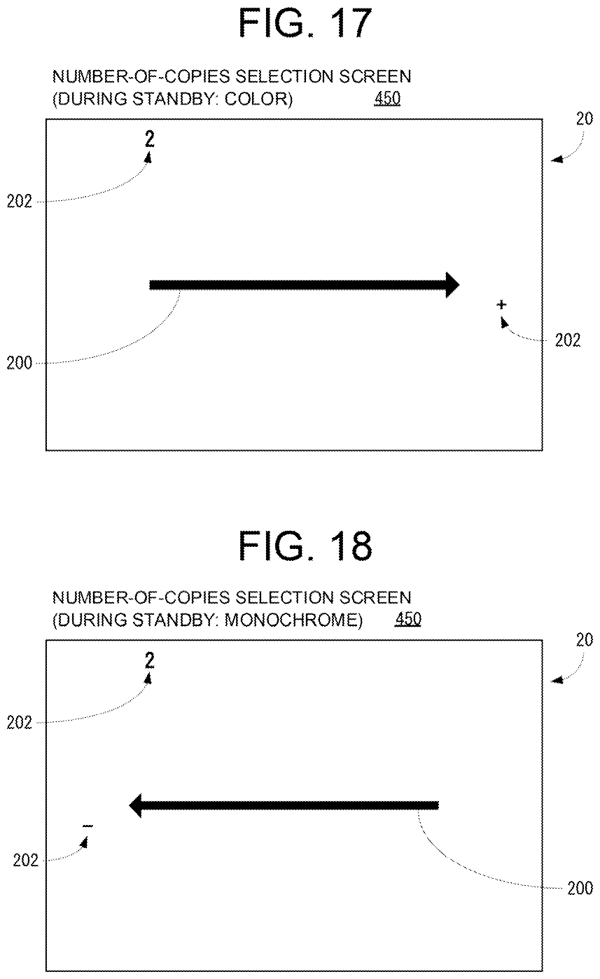

In the number-of-copies selection screen 450 illustrated in FIGS. 17 and 18, the number (here, 2) 204 indicating the number of copies is displayed in yellow. It is noted that when the number-of-copies selection screen 450 is firstly displayed, the number 204 of “1” is displayed for the number-of-copies. In the number-of-copies selection screen 450 illustrated in FIG. 17, the symbol 200 of the rightward arrow is displayed in yellow to notify the rightward movement as a gesture for increasing the number of copies. On the other hand, in the number-of-copies selection screen 450 illustrated in FIG. 18, the symbol 200 of the leftward arrow is displayed in yellow to notify the leftward movement as a gesture for decreasing the number of copies.

The number-of-copies selection screens 450 illustrated in FIGS. 17 and 18 are alternately displayed on the display 20 until the selection of the number of copies is completed. In the present embodiment, if the instruction with the gesture for selecting the number of copies is not detected for at least a third predetermined time period (in the present embodiment, three seconds), it is determined that the selection of the number of copies is completed.

Upon completion of the selection of the number of copies, the confirmation screen (hereinafter, referred to as “confirmation screen for the number of copies”) for confirming whether “OK” or “Cancel” is selected for the selected number of copies is displayed on the display 20. The confirmation screen for the number of copies is similar to the above confirmation screen 350, but here, the number 204 indicating the selected number of copies is displayed in red to confirm whether “OK” or “Cancel” is selected for the selected number of copies. The symbol 200 of the arrow in the case of “OK” and in the case of “Cancel” is the same as that of the confirmation screen 350.

When “Cancel” is selected for the number of copies, the screen returns to the number-of-copies selection screen 450 to select the number-of-copies again. On the other hand, when “OK” is selected for the number of copies, the screen 500 (hereinafter, referred to as “execution screen”) for executing the function (here, “Copy”) is displayed on the display 20.

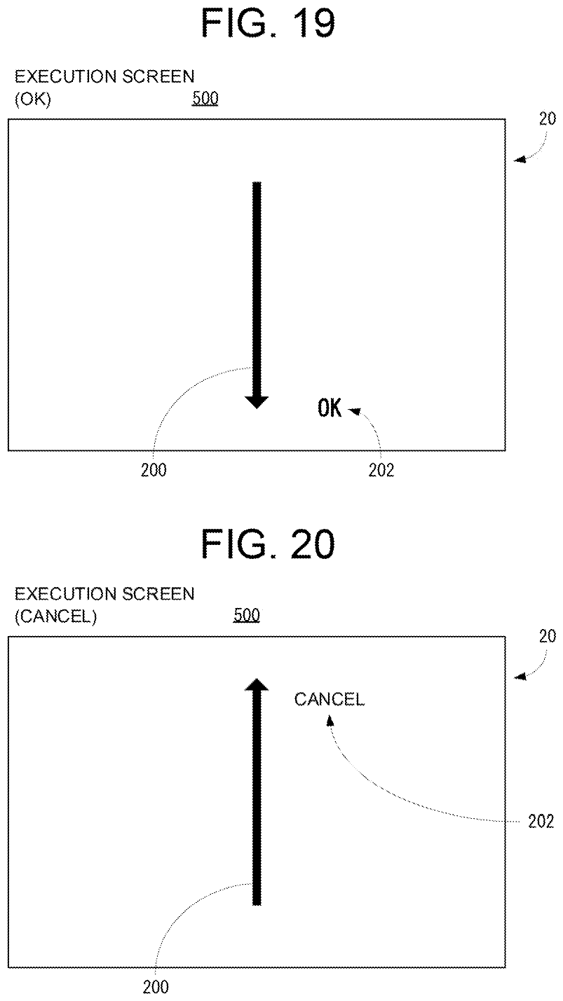

In the execution screen 500 illustrated in FIG. 19, the symbol 200 of the downward arrow is displayed in green to notify the downward movement as a gesture for instructing (“OK”) execution of “Copy”. On the other hand, in the execution screen 500 illustrated in FIG. 20, the symbol 200 of the upward arrow is displayed to indicate a gesture for moving to the upward movement as a gesture for instructing “Cancel” of “Copy”.

The execution screens 500 illustrated in FIGS. 19 and 20 are alternately displayed on the display 20 until the execution or cancellation of “Copy” is instructed, that is, until the downward movement or the upward movement is detected. It is noted that while the execution screen 500 illustrated in FIG. 19 is displayed, the symbol 200 of the downward arrow is displayed three times, and while the execution screen 500 illustrated in FIG. 20 is displayed, the symbol 200 of the upward arrow is displayed three times.

If the cancellation of “Copy” is instructed, the selected function and operation condition are reset, and the screen returns to the home screen 300. On the other hand, if the execution of “Copy” is instructed, “Copy” is executed or started. Therefore, the document is read by the image reader 30, and output images equal in quantity to the number of copies and corresponding to the document are printed on a recording medium such as paper by the image former 32.

Although not illustrated, if another function such as “Scan”, “Fax”, and “User preset” is selected, similarly, a gesture for the instructable content is notified to the user, the user's gesture is detected, and a process according to the detected gesture is executed.

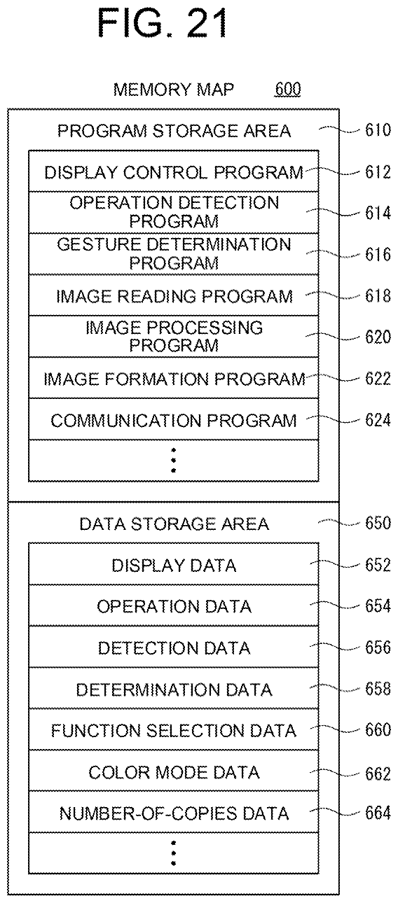

FIG. 21 illustrates an example of a memory map 600 of the RAM 14 illustrated in FIG. 2. As illustrated in FIG. 21, the RAM 14 includes a program storage area 610 and a data storage area 650. In the program storage area 610 out of these areas, a control program of the image formation apparatus 10 is stored. Specifically, the control program includes a display control program 612, an operation detection program 614, a gesture determination program 616, an image reading program 618, an image processing program 620, an image formation program 622, and a communication program 624.

The display control program 612 is a program for causing various types of screens such as the home screen 300, the confirmation screen 350, the color mode selection screen 400, the number-of-copies selection screen 450, and the execution screen 500 to be displayed on the display 20, and controlling the LED drive circuit 62 according to display data 652 for notifying an error.

The operation detection program 614 is a program for detecting an operation state of an operation button 26a and a detection state (on/off) of the gesture of the user, that is, the infrared sensors 230 to 236. The gesture determination program 616 is a program for detecting the gesture, based on the detection state of the infrared sensors 230 to 236 and determining a type of the detected gesture.

The image reading program 618 is a program for controlling the image reader 30. The image processing program 620 is a program for performing an appropriate image process on various types of image data such as read image data generated by the image reader 30.

The image formation program 622 is a program for controlling the image former 32. The communication program 624 is a program for performing wired or wireless communication (transmitting or/and receiving data) with another computer.

Although not illustrated, the program storage area 610 also stores other programs such as an audio output program for outputting audio and a saving program for saving image data subjected to image processing in the HDD 16 or the like.

The data storage area 650 stores various types of data. Examples of the various types of data include the display data 652, operation data 654, detection data 656, determination data 658, function selection data 660, color mode data 662, and number-of-copies data 664.

The display data 652 is data for timings of turning on and off the plurality of LEDs 220a to 220j, 222a to 222g, 224a to 224h, and 226a to 226j according to a chronological order and a light emission pattern for controlling a color to be lit, is previously prepared correspondingly to the type of screens to be displayed and an error to be notified, and read from the HDD 16 where necessary.

The operation data 654 is data representing an operation state of the operation button 26a. The data representing the operation state of the operation button 26a is data indicating that the user depresses the operation button 26a, and is stored in chronological order. The operation data 654 is deleted after being used for processes of the CPU 12.

The detection data 656 is data representing a detection state of the infrared sensors 230 to 236. The data representing the detection state of the infrared sensors 230 to 236 is data indicating on (detection)/off (non-detection) of each infrared sensor 230, and is stored in chronological order. The detection data 656 is deleted after the type of gesture is determined.

The determination data 658 is data indicating the type of gesture determined based on the data representing the detection state of the infrared sensors 230 to 236. In the present embodiment, there are five types of gestures, that is, the leftward movement, the rightward movement, the upward movement, the downward movement, or a specific operation. The determination data 658 is deleted after being used for processes of the CPU 12.

The function selection data 660 is data indicating a function selected by the user when the home screen 300 is displayed. In the present embodiment, the function selection data 660 indicates the type of “Copy”, “Scan”, “Fax” or “User preset”. Before the user selects the function, the function selection data 660 is Null data. With reference to the function selection data 660, the display of the screen for selecting the operation condition according to each function and various types of confirmation screens is controlled, and a process for the content instructed with a gesture of the user is executed.

The color mode data 662 is data indicating a color mode selected by the user, that is, a color or a monochrome, when the color mode selection screen 400 is displayed. It is noted that before the user selects the color mode, the color mode data 662 is data indicating the color or the monochrome set by default.

The number-of-copies data 664 is data indicating the number of copies selected by the user when the number-of-copies selection screen 450 is displayed. It is noted that before the user selects the number of copies, the number-of-copies data 664 is data indicating an initial value (for example, 1) set by default.

Although not illustrated, the data storage area 650 stores another data necessary for executing the control program, and also stores a counter (or a timer) or/and a flag necessary for executing the control program.

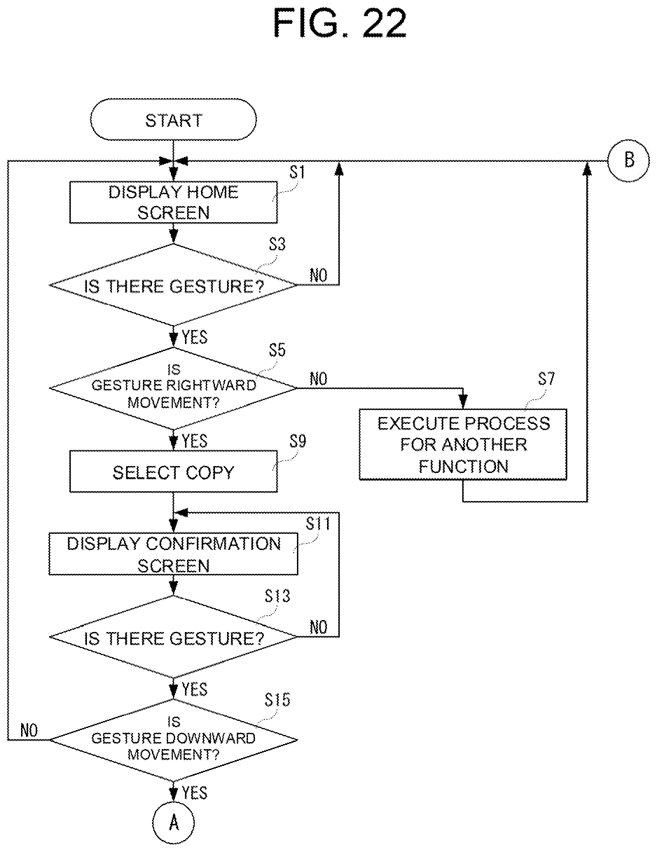

FIGS. 22 to 25 are flowcharts illustrating an example of an overall control process of the CPU 12 illustrated in FIG. 2. The control process will be described below, and if the same process content is described, the same process will be briefly described.

As illustrated in FIG. 22, when the CPU 12 starts the control process, the home screens 300 as illustrated in FIGS. 5 to 8 are displayed on the display 20 in step S1. In the control process, it is mentioned that the home screen 300 is displayed on the display 20, but as described above, the home screens 300 illustrated in FIGS. 5 to 8 are displayed in order, and in each of the home screens 300 illustrated in FIGS. 5 to 8, the character string 202 indicating the function is displayed in a predetermined color assigned to the function, and the symbol 200 of the arrow is displayed several times (in the present embodiment, three times) to extend in the same predetermined color as that of the character string 202 indicating the function. Therefore, the user can see the home screen 300 to know a gesture for selecting a desired function. Except for the colors of the displayed symbol 200 and the character string 202, these apply to the confirmation screen 350 described later, the color mode selection screen 400, the color mode confirmation screen, the number-of-copies selection screen 450, the confirmation screen of the number of copies, and the execution screen 500. It is noted that in the confirmation screen 350, the color mode selection screen 400, the color mode confirmation screen, the number-of-copies selection screen 450, the confirmation screen of the number of copies, and the execution screen 500, the color of the displayed symbol 200 and the character string 202 is as described above.

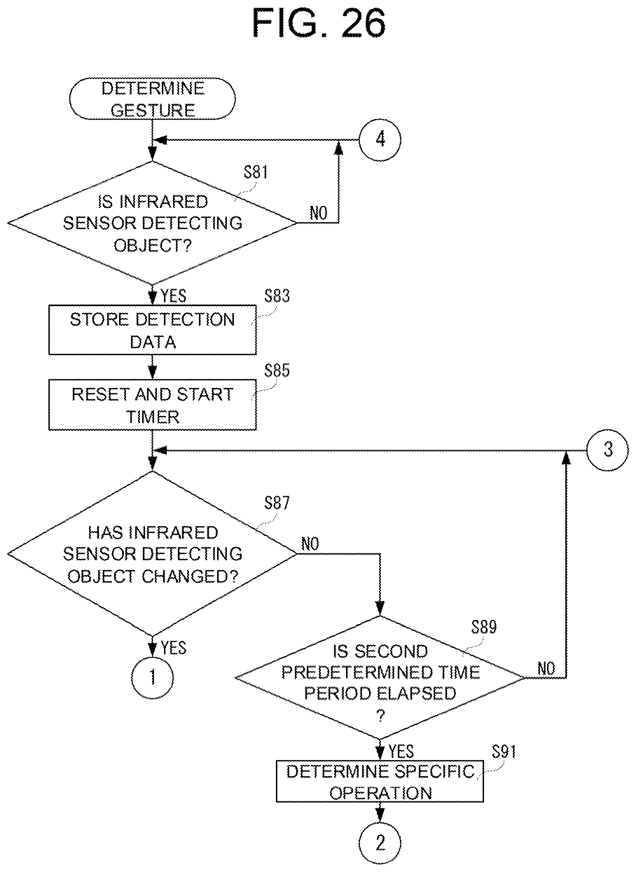

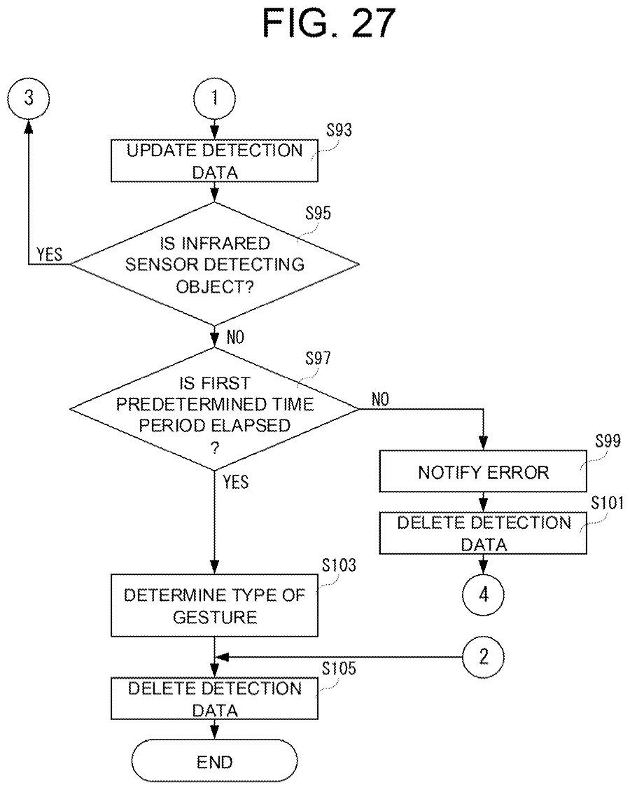

In the subsequent step S3, it is determined whether there is a gesture. Here, the CPU 12 determines whether the determination data 658 for a gesture type determined in a gesture determination process (see FIGS. 26 and 27) executed in parallel with the control process is stored in the RAM 14. The same applies to the following case where it is determined whether there is a gesture.

If “NO” in step S3, that is, if there is no gesture, the process returns to step S1. On the other hand, if “YES” in step S3, that is, if there is a gesture, it is determined in step S5 whether the gesture is the rightward movement.

If “NO” in step S5, that is, if the gesture is not the rightward movement, in step S7, a process for the selected other function, that is, the “Scan”, “Fax” or “User preset” is executed, and the process returns to step S1.

On the other hand, if “YES” in step S5, that is, if the gesture is the rightward movement, in step S9, “Copy” is selected, that is, the function selection data 660 in which the function is “Copy” is stored, and in step S11, the confirmation screen 350 as illustrated in FIGS. 13 and 14 is displayed on the display 20.

In the subsequent step S13, it is determined whether there is a gesture. If “NO” in step S13, the process returns to step S11. On the other hand, if “YES” in step S13, it is determined in step S15 whether the gesture is the downward movement.

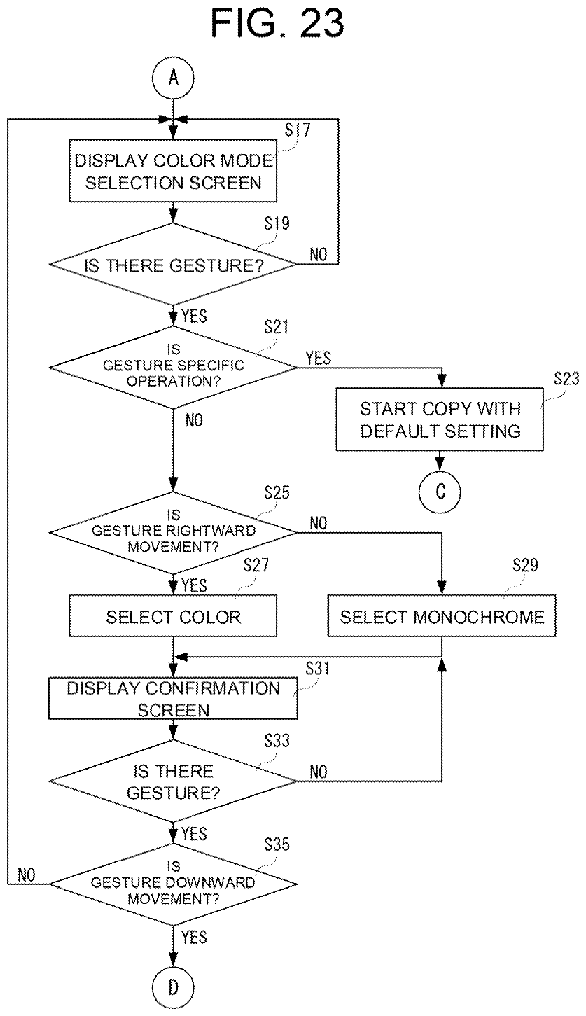

If “NO” in step S15, that is, if the gesture is the upward movement, “Cancel” is determined, the function selection data 660 is updated to Null data, and the process returns to step S1. On the other hand, if “YES” in step S15, that is, if the gesture is the downward movement, “OK” is determined, and in step S17 illustrated in FIG. 23, the color mode selection screen 400 as illustrated in FIGS. 15 and 16 is displayed on the display 20.

In the subsequent step S19, it is determined whether there is a gesture. If “NO” in step S19, the process returns to step S17. On the other hand, if “YES” in step S17, it is determined in step S21 whether the gesture is the specific operation.

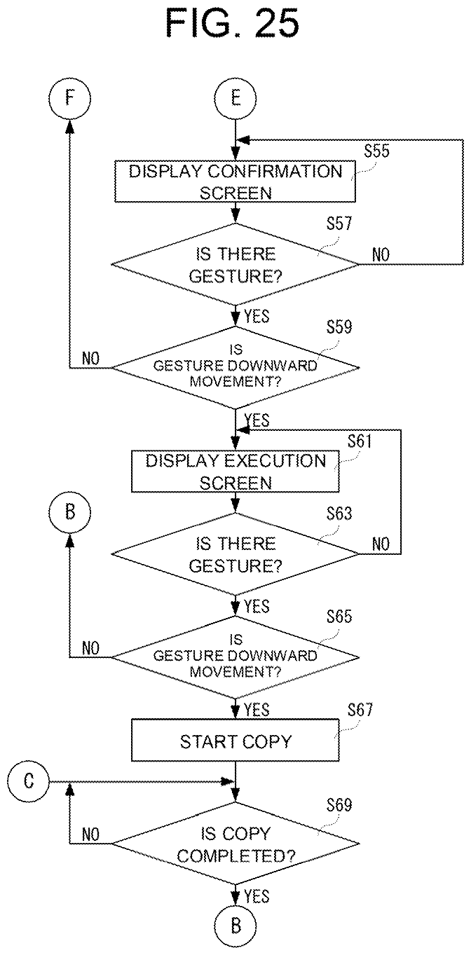

If “YES” in step S21, that is, if the specific operation is detected, in step S23, “Copy” is started according to the default settings, and the process proceeds to step S69 illustrated in FIG. 25. On the other hand, if “NO” in step S21, that is, if the specific operation is not detected, it is determined in step S25 whether the gesture is the rightward movement.

If “YES” in step S25, a color is selected in step S27, that is, the color mode data 662 indicating a color is stored in the RAM 14, and the process proceeds to step S31. On the other hand, if “NO” in step S25, monochrome is selected in step S29, that is, the color mode data 662 indicating monochrome is stored in the RAM 14, and the process proceeds to step S31.

In step S31, the color mode confirmation screen is displayed. In the subsequent step S33, it is determined whether there is a gesture. If “NO” in step S33, the process returns to step S31. On the other hand, if “YES” in step S33, it is determined in step S35 whether the gesture is the downward movement.

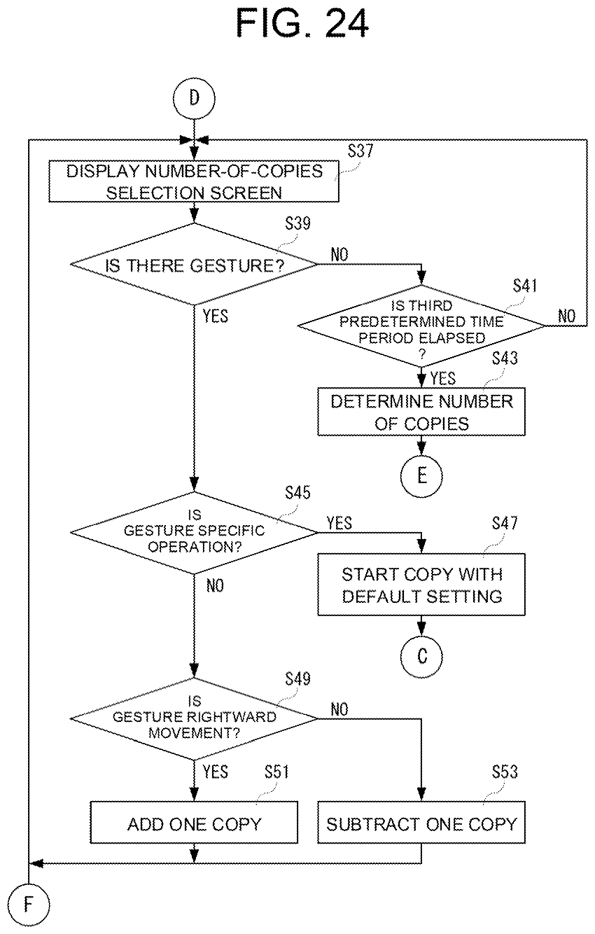

If “NO” in step S35, the color mode data 662 is restored to the default setting, and the process returns to step S17. On the other hand, if “YES” in step S35, the number-of-copies selection screen 450 as illustrated in FIGS. 17 and 18 is displayed on the display 20 in step S37 illustrated in FIG. 24.

In the subsequent step S39, it is determined whether there is a gesture. If “NO” in step S39, it is determined in step S41 whether a time period involving no gesture is longer than the third predetermined time period (three seconds in the present embodiment). It is noted that although not illustrated, a timer that counts the time period involving no gesture (for convenience of explanation, referred to as “first timer”) is provided in the RAM 14, and when it is first determined in step S39 that there is no gesture, the first timer is started, and the time period involving no gesture is counted.

If “NO” in step S41, that is, if the time period involving no gesture is not longer than the third predetermined time period, the process returns to step S37. On the other hand, if “YES” in step S41, the number of copies is determined in step S43, and the process proceeds to step S55 illustrated in FIG. 25.

If “YES” in step S39, that is, if there is a gesture, it is determined in step S45 whether the gesture is the specific operation. If “YES” in step S45, “Copy” is started according to the default settings in step S47, and the process proceeds to step S69. On the other hand, if “NO” in step S45, it is determined in step S49 whether the gesture is the rightward movement.

If “YES” in step S49, the number of copies is incremented by one in step S51, and the process returns to step S37. On the other hand, if “NO” in step S49, the number of copies is subtracted by one in step S53, and the process returns to step S37. By executing the process of step S51 or S53, the number-of-copies data 664 is updated, and the number of copies of the number-of-copies selection screen 450 displayed later is also changed. It is noted that if the number of copies indicated by the number-of-copies data 664 is one, the number-of-copies data 664 is not updated even if the gesture indicates the leftward movement.

As illustrated in FIG. 25, in step S55, a confirmation screen for the number of copies is displayed on the display 20. In the subsequent step S57, it is determined whether there is a gesture. If “NO” in step S57, the process returns to step S55. On the other hand, if “YES” in step S57, it is determined in step S59 whether the gesture is the downward movement.

If “NO” in step S59, the process returns to step S37 illustrated in FIG. 24. On the other hand, if “YES” in step S59, the execution screen 500 as illustrated in FIGS. 19 and 20 is displayed on the display 20 in step S61.

In the subsequent step S63, it is determined whether there is a gesture. If “NO” in step S63, the process returns to step S61. On the other hand, if “YES” in step S63, it is determined in step S65 whether the gesture is the downward movement.

If “NO” in step S65, the function selection data 660, the color mode data 662, and the number-of-copies data 664 are restored to the initial state, and the process returns to step S1. On the other hand, if “YES” in step S65, “Copy” is started in the color mode indicated by the color mode data 662 in step S67. “Copy” is executed for the number of times corresponding to the number of copies indicated by the number-of-copies data 664.

In the subsequent step S69, it is determined whether the “Copy” is completed. If “NO” in step S69, that is, if “Copy” is not completed, the process returns to step S69. On the other hand, if “YES” in step S69, that is, if “Copy” is completed, the function selection data 660, the color mode data 662, and the number-of-copies data 664 are restored to the initial state, and the process returns to step S1.

FIGS. 26 and 27 are flowcharts each illustrating an example of the gesture determination process of the CPU 12 illustrated in FIG. 2. As described above, the gesture determination process is executed in parallel with the above control process, and specifically, starts when each screen of the confirmation screen 350, the color mode selection screen 400, the color mode confirmation screen, the number-of-copies selection screen 450, the number-of-copies confirmation screen, and the execution screen 500 is displayed.

As illustrated in FIG. 26, upon starting the gesture determination process, the CPU 12 determines in step S81 whether the infrared sensors 230 to 236 detect an object. Here, if any one of the infrared sensors 230 to 236 detects an object, the CPU 12 determines “YES”, and if none of the infrared sensors 230 to 236 detects an object, the CPU 12 determines “NO”.

If “NO” in step S81, the process returns to step S81. On the other hand, if “YES” in step S81, the detection data 656 is stored in the RAM 14 in step S83. In step S83, the detection data 656 describing identification information of the infrared sensors 230 to 236 that detect the object is stored.

In the subsequent step S85, a timer (referred to as “second timer” for convenience of explanation) is reset and started. Although not illustrated, the second timer is provided in the RAM 14 and counts a time period during which the same infrared sensors 230 to 236 continuously detects the object. It is noted that the second timer is a timer different from the first timer.

In the subsequent step S87, it is determined whether the infrared sensors 230 to 236 that detect the object changes. Here, the CPU 12 determines whether the detection state (on/off) changes in any one or more of the infrared sensors 230 to 236.

If “YES” in step S87, that is, if the infrared sensors 230 to 236 that detect the object changes, the process proceeds to step S93 illustrated in FIG. 27. On the other hand, if “NO” in step S87, that is, if the infrared sensors 230 to 236 that detect the object does not change, it is determined in step S89 whether the count value of the timer passes the second predetermined time period (three seconds in the present embodiment).

If “NO” in step S89, that is, if the count value of the timer does not pass the second predetermined time period, the process returns to step S87. On the other hand, if “YES” in step S89, that is, if the count value of the timer passes the second predetermined time period, the specific operation is determined in step S91, that is, the determination data 658 indicating the specific operation is stored in the RAM 14, and the process proceeds to step S105 illustrated in FIG. 27.

As illustrated in FIG. 27, in step S93, the detection data is updated. Here, the CPU 12 stores, into the RAM 14, the detection data 656 obtained by chronologically adding the identification information of the infrared sensors 230 to 236 that detect the object in determining “YES” in step S87 to the identification information stored in step S83.

In the subsequent step S95, it is determined whether the infrared sensors 230 to 236 detect the object. This determination is the same as that in step S81. If “YES” in step S95, the process returns to step S87 illustrated in FIG. 26. On the other hand, if “NO” in step S95, it is determined in step S97 whether the count value of the timer passes the first predetermined time period (one second in the present embodiment).

If “NO” in step S97, that is, if the count value of the timer does not pass the first predetermined time period, an error is notified in step S99, the detection data 656 is deleted in step S101, and the process returns to S81. In step S99, the CPU 12 controls the LED drive circuit 62, based on the display data 652 in notifying an error, and causes all of the LEDs 220a to 220j, 222a to 222g, 224a to 224h, and 226a to 226j to blink in red for several seconds.

On the other hand, if “YES” in step S97, that is, if the count value of the timer passes the first predetermined time period, the type of the gesture is determined in step S103, the detection data is deleted in step S105, and the gesture determination process is ended. In step S103, as described above, the CPU 12 calculates a direction from the infrared sensors 230 to 236 corresponding to the identification information described first toward the infrared sensors 230 to 236 corresponding to the identification information described last, out of the identification information included in the detection data 656, and stores the determination data 658 indicating a movement in the calculated direction, into the RAM 14.

According to the present embodiment, an operatable gesture is notified by turning on and off the plurality of LEDs, and thus, a user can inexpensively and simply apply an instruction with the gesture.

It is noted that in the present embodiment, the gestures in the four directions, that is, the leftward movement, the rightward movement, the upward movement, and the downward movement, are employed to instruct the selection of the function, the selection of the operation condition (in the above embodiment, the selection of the color mode and the selection of the number of copies), and execution or cancellation of the function, but if the number of functions is two, it is possible to apply an instruction with a gesture in two directions, that is, a left-to-right direction and an up-and-down direction.

In the present embodiment, the symbol of the arrow is displayed to extend to notify the gesture in the four directions, that is, the leftward movement, the rightward movement, the upward movement, and the downward movement, but this is not limiting. In another example, the entire symbol of the arrow may be blinked several times at an interval of the first predetermined time period. Even in this way, a direction in which the hand is moved can be known from the arrow, and a speed at which the hand is moved can be intuitively known from a blinking time interval.

In the present embodiment, the color LEDs are employed to display the arrow and the character string in different colors for each function, but this is not limiting. Monochromatic LEDs may be employed to simply display the arrow and the character strings. In addition, when LEDs in two colors may be employed to display the arrow and the character strings in different colors so that one of two setting items is selected and the execution or the cancellation of the function is instructed.

In the present embodiment, description is given of the image formation apparatus having four functions, that is, a printer function, a copying function, a facsimile function, and a scanning function, but if the image formation apparatus is an apparatus dedicated to the copying function, the facsimile function, or the scanning function, the home screen is omitted.

In the flowcharts illustrated in FIGS. 22 to 27, if the same result can be obtained, the order of processes may be changed as appropriate. The case where according to the flowcharts illustrated in FIGS. 22 to 27, the CPU 12 executes the control process and the gesture determination process is described, but another computer communicatively connected to the image formation apparatus 10 may execute some of the processes.

The present invention may be also provided not only in a form of an apparatus such as the image formation apparatus, but also in a form of a program (software) that is a control program of the image formation apparatus and in a form of a method such as a control method of the image formation apparatus.

A program may be recorded in a computer-readable recording medium and be provided, and a computer system may be caused to read and execute the program recorded in the recording medium to perform a process of each component. The “computer system” mentioned here includes an OS and hardware such as a peripheral device.

The “computer-readable recording medium” refers to a portable medium such as a flexible disk, a magneto-optical disk, a ROM, or a CD-ROM, or a storage device such as a hard disk built inside the computer system.

What is claimed is:

1. An image formation apparatus, comprising:
a plurality of infrared sensors;
a plurality of LEDs arranged around the plurality of infrared sensors; and
a notifier that notifies an instructable content and a gesture for instructing the instructable content by turning on some of the plurality of LEDs.

2. The image formation apparatus according to claim 1, comprising: a display arranged with the plurality of LEDs, wherein
the plurality of infrared sensors are arranged at upper and lower areas or/and left and right areas of the display.

3. The image formation apparatus according to claim 2, wherein some of the plurality of LEDs are arrayed linearly along the plurality of infrared sensors arrayed linearly at the upper and lower areas or/and left and right areas.

4. The image formation apparatus according to claim 2, wherein the gesture includes moving a hand in an up-down direction or/and left-right direction with respect to the display.

5. The image formation apparatus according to claim 4, wherein the plurality of LEDs emit light according to a light emission pattern based on the gesture.

6. The image formation apparatus according to claim 5, wherein the light emission pattern is a pattern in which the plurality of LEDs are turned on to notify a direction in which a user moves a hand.

7. The image formation apparatus according to claim 5, wherein the light emission pattern is a pattern in which the plurality of LEDs are additionally turned on in a predetermined order with a predetermined time interval to notify a direction in which a user moves a hand.

8. The image formation apparatus according to claim 3, wherein the gesture includes moving a hand in an up-down direction or/and left-right direction with respect to the display.

9. The image formation apparatus according to claim 8, wherein the plurality of LEDs emit light according to a light emission pattern based on the gesture.

10. The image formation apparatus according to claim 9, wherein the light emission pattern is a pattern in which the plurality of LEDs are turned on to notify a direction in which a user moves a hand.

11. The image formation apparatus according to claim 9, wherein the light emission pattern is a pattern in which the plurality of LEDs are additionally turned on in a predetermined order with a predetermined time interval to notify a direction in which a user moves a hand.

12. A non-transitory recording medium for recording a control program of an image formation apparatus including a plurality of infrared sensors and a plurality of LEDs arranged around the plurality of infrared sensors,
the control program causing a processor of the image formation apparatus to execute:
a notification step for notifying an instructable content and a gesture for instructing the instructable content by tuning on some of the plurality of LEDs.

13. A control method of an image formation apparatus including a plurality of infrared sensors, and a plurality of LEDs arranged around the plurality of infrared sensors, the control method comprising:
notifying an instructable content and a gesture for instructing the instructable content by turning on some of the plurality of LEDs.
